(19) United States
(12) Patent Application Publication
(10) Pub. No.: US 2002/0076203 A1
(43) Pub. Date: Jun. 20, 2002

(54) Playback apparatus and method of timely playing back a recorded program

(76) Inventor: Masaru Takahashi, Fukaya-shi (JP)

Correspondence Address: Pillsbury Madison & Sutro, LLP, East Tower, Ninth Floor, 1100 New York Avenue, N.W., Washington, DC, 20005-3918, US

(21) Appl. No.: 09/808,365

(22) Filed: Mar. 15, 2001

(30) Foreign Application Priority Data
Nov. 30, 2000 (JP) 2000-364505

(51) Int. Cl. H04N 5/91; H04N 5/445; G06F 3/00; G06F 13/00

(52) U.S. Cl. 386/83; 725/39

(57) ABSTRACT

An information recording/playback apparatus of this invention records a plurality of desired programs on a recording medium, reserves in advance the playback order of the plurality of recorded programs, creates a user original program guide on the basis of the reserved playback order, and plays back the plurality of recorded programs in an order based on the program guide.

### CROSS-REFERENCE TO RELATED APPLICATIONS

This application is based upon and claims the benefit of priority from the prior Japanese Patent Application No. 2000-364505, filed Nov. 30, 2000, the entire contents of which are incorporated herein by reference.

### BACKGROUND OF THE INVENTION

The present invention relates to a playback method and apparatus for playing back a recorded program.

In recent years, a lot of programs can be watched by ground wave broadcast, BS, CS, and the like. The number of channels is expected to further increase in the future as digital broadcast becomes more popular. This is all in preparation for an environment where a user can select any program of his/her taste from diverse channels.

However, programs are not always timely offered to users by the above. That is, a program desired by a user is not always broadcast at the time of his/her choice. The desired program must be recorded in advance and played back at a desired timing. However, when an enormous number of programs are recorded, it is sometimes difficult to determine the order to watch the recorded programs.

Jpn. Pat. Appln. KOKAI Publication No. 11-345446 discloses an automatic recording method of automatically learning the taste of a user and automatically reserving recording of programs of the taste. However, it does not solve the above problem.

Jpn. Pat. Appln. KOKAI Publication No. 2000-48029 discloses a recording/playback method capable of easily searching for a timely program for a user and recording/playback the program. However, the technique disclosed in this prior art still does not solve the above problem.

### BRIEF SUMMARY OF THE INVENTION

The present invention has been made to solve the above problem, and has as its object to provide a playback apparatus and method capable of timely playing back a recorded program.

In order to solve the above problem and achieve the above object, a playback apparatus and method of the present invention have the following arrangements.

(1) A playback apparatus of the present invention comprises reserve means for recording a plurality of desired programs on a recording medium and reserving in advance a playback order of the plurality of recorded programs, creation means for creating a user original program guide on the basis of the playback order reserved by the reserve means, and playback means for playing back the plurality of recorded programs in an order based on the program guide.

(2) A playback method of the present invention comprises the first step of reserving in advance a playback order of a plurality of recorded programs, the second step of creating a user original program guide on the basis of the playback order reserved in the first step, and the third step of playing back the plurality of recorded programs in an order based on the program guide created in the second step.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a playback apparatus (a recording/playback apparatus) of the present invention;

FIG. 2 is a flow chart showing program reserve processing;

FIG. 3 is a table showing a program reserve window when “no automatic playback” is selected;

FIG. 4 is a table showing a program reserve window when “automatic playback” is selected;

FIG. 5 is a flow chart showing reserved recording processing;

FIG. 6 is a flow chart showing playback processing;

FIG. 7 is a view showing an EPG in which a user original EPG and an EPG corresponding to current broadcast are parallelly displayed; and

FIG. 8 is a flow chart showing reserve processing with automatic re-formation.

### DETAILED DESCRIPTION OF THE INVENTION

The embodiment of the present invention will be described below with reference to the accompanying drawing.

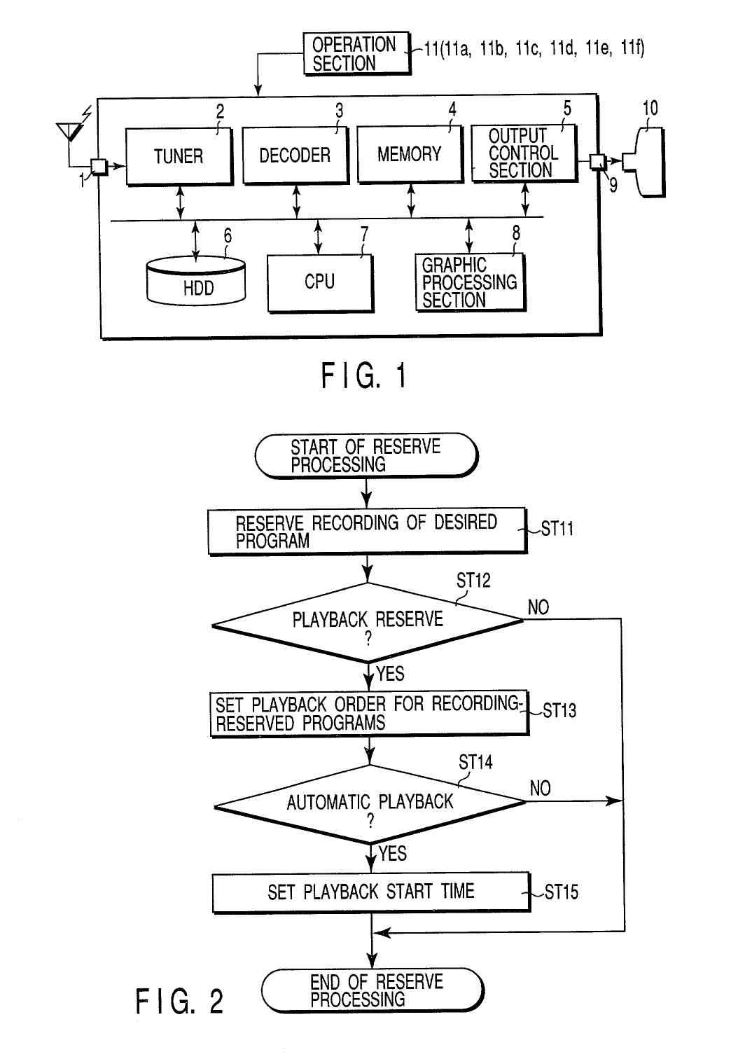

FIG. 1 is a block diagram showing a playback apparatus (a recording/playback apparatus) of the present invention. This playback apparatus can receive program broadcast, record the received program broadcast, or play back the received program broadcast. As shown in FIG. 1, the playback apparatus comprises an input section 1, tuner 2, decoder 3, memory 4, output control section 5, HDD (Hard Disk Drive) 6, CPU (Central Processing Unit) 7, graphic processing section 8, output section 9, display section 10, and operation section 11. Note that the tuner 2, HDD 6, and display section 10 are not always indispensable components and may be externally attached to the playback apparatus of the present invention. In this case, the playback apparatus of the present invention has a connection terminal to the tuner 2 and a connection terminal to the HDD 6.

A broadcast signal received by an antenna is input to the input section 1. This broadcast signal contains a video signal and audio signal corresponding to each program. Program information is superposed on the video and audio signals. The program information contains channel identification information representing a channel number and channel name, program identification information representing a program title, program broadcast day information representing a program broadcast day, program broadcast start time information representing a program broadcast start time, program broadcast end time information representing a program broadcast end time, length information representing the length of the broadcast time of the program broadcast.

The HDD 6 stores desired program data extracted from the broadcast signal input from the input section 1 through the tuner 2. The decoder 3 decodes the program broadcast input from the input section 1. The output control section 5 controls output of the program broadcast decoded by the decoder 3 and causes the display section 10 to display the program broadcast through the output section 9. The memory 4 stores, e.g., program reserve information. The CPU 7 controls the entire playback apparatus. The graphic processing section 8 creates an EPG (Electronic Program Guide) corresponding to broadcast on the basis of the above program information. The EPG created by the graphic processing section 8 is displayed on the display section 10 through the output section 9 under the output control by the output control section 5. The operation section 11 is, e.g., a remote controller. The operation section 11 has various keys for receiving various input operations. For example, a recording reserve key 11a, playback reserve key 11b, playback mode selection key 11c, playback start time setting key lid, playback start key 11e, and EPG display key 11f are prepared.

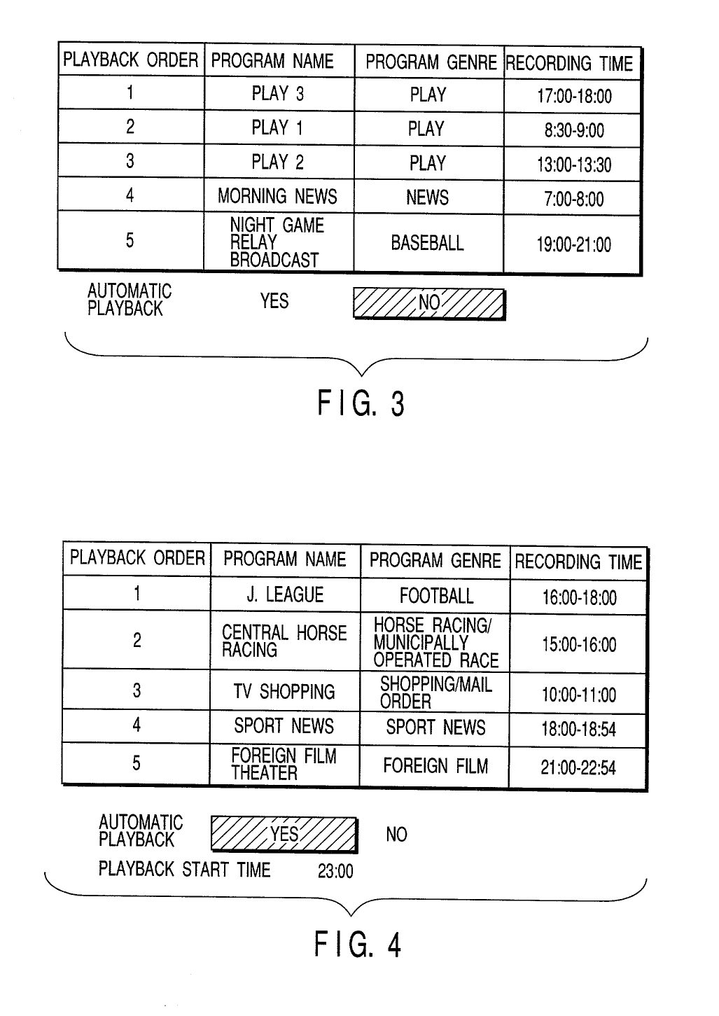

Program reserve processing will be described next with reference to FIGS. 2 to 4. FIG. 2 is a flow chart showing program reserve processing. FIGS. 3 and 4 are tables showing program reserve windows. In correspondence with program reserve operation received through the recording reserve key 11a of the operation section 11, a program reserve window is displayed on the display section 10, and recording of a desired program is reserved (ST11). For example, assume that recording of a plurality of programs is reserved. If playback reserve is not to be done (NO in ST12), the program reserve processing is ended. If playback reserve is to be done (YES in ST12), the playback order of recording-reserved programs, i.e., programs which will be recorded later is set in correspondence with playback order setting operation received through the playback reserve key 11b of the operation section 11 (ST13). At this time, items for selecting “automatic playback (automatic playback mode)” or “no automatic playback (manual playback mode)” are displayed on the program reserve window. When “no automatic playback” is selected through the playback mode selection key 11C of the operation section 11 (NO in ST14), as shown in FIG. 3, the program reserve processing is ended. When “automatic playback” is selected through the playback mode selection key 11C of the operation section 11 (YES in ST14), as shown in FIG. 4, setting of the playback start time is requested. After that, the playback start time is set in correspondence with a playback start time received through the playback start time setting key (e.g., ten-key pad) lid of the operation section 11 (ST15). Program reserve information generated by the above-described reserve processing is stored in the memory 4.

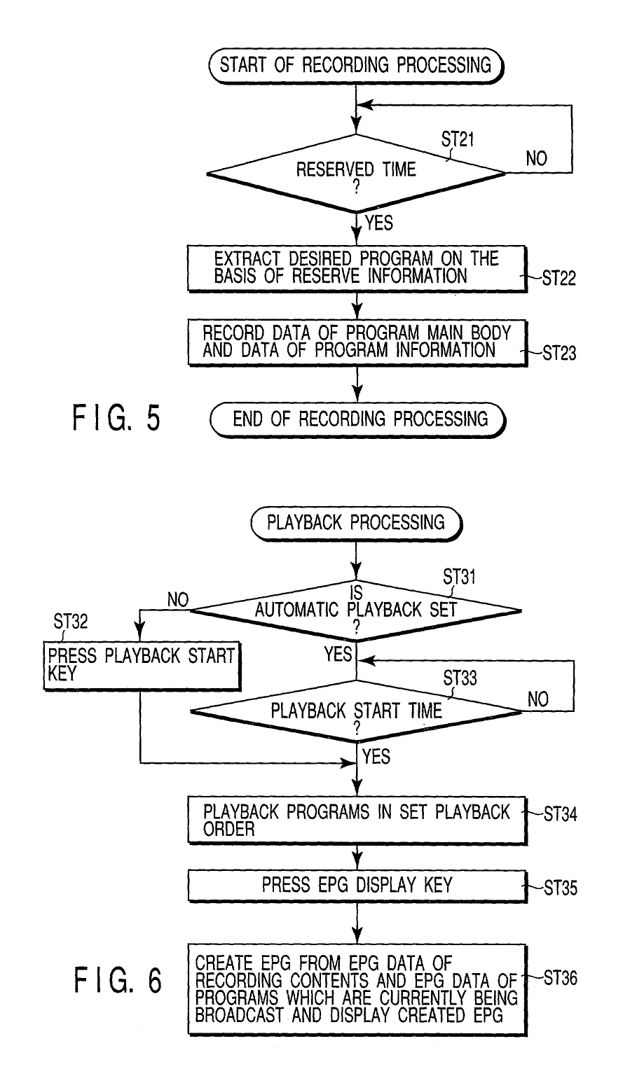

Reserved recording processing will be described next with reference to FIG. 5. The CPU 7 causes the HDD 6 (recording medium) to record desired program data on the basis of the program reserve information stored in the memory 4. More specifically, when the reserved recording time comes (YES in ST21), the CPU 7 extracts, through the tuner 2, desired program data from the broadcast signal provided from the input section 1 (ST22) and causes the HDD 6 to record this program data (ST23). Simultaneously, the CPU 7 also extracts program information corresponding to the program to be recorded and causes the HDD 6 to record it (ST23).

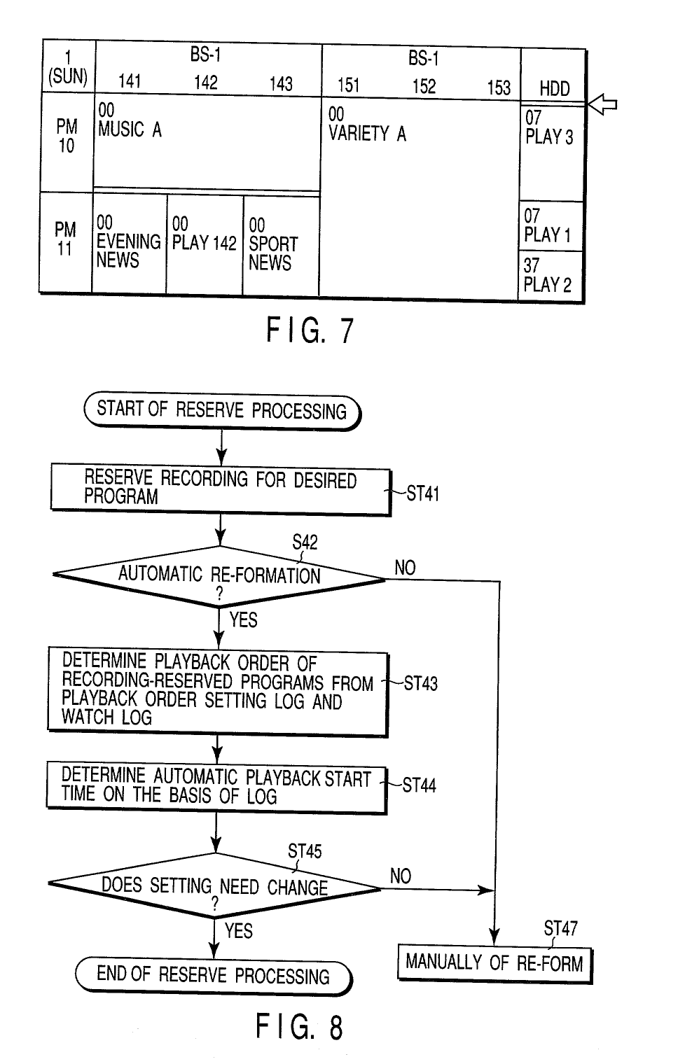

Playback processing for a recorded program will be described next with reference to FIG. 6. When “no automatic playback” is selected as shown in FIG. 3 (NO in ST31), in correspondence with the playback start operation received through the playback start key 11e of the operation section 11 (ST32), playback based on the set playback order (user original EPG to be described later) is started under the playback control by the CPU 7. That is, the program recorder in the HDD 6 is played back on the basis of the playback order in the program reserve information stored in the memory 4 (ST34). During this playback, in correspondence with the display operation received through the EPG display key 11f of the operation section 11 (ST35), an EPG as shown in FIG. 7 is created and displayed (ST36). Alternatively, when “automatic playback” is selected as shown in FIG. 4 (YES in ST31), playback based on the set playback order (user original EPG to be described later) is started under the playback control by the CPU 7 when the set playback start time comes (YES in ST33). That is, the program record in the HDD 6 is played back on the basis of the playback start time and playback order in the program reserve information stored in the memory 4 (ST34). During this playback, in correspondence with the display operation received through the EPG display key 11f of the operation section 11 (ST35), an EPG as shown in FIG. 7 is created and displayed (ST36).

The EPG shown in FIG. 7 will be described. The EPG shown in FIG. 7 is an EPG (linked program guide) that links an EPG corresponding to broadcast with a user original EPG. An EPG corresponding to broadcast is an EPG corresponding to programs which are presently being broadcast. In other words, it is an EPG created on the basis of pieces of program information which are currently being received. To the contrary, the user original EPG is created on the basis of program information recorder in ST23, playback order set in ST13, and playback time set in ST15. When the two EPGs are displayed with a link between them, the actual programs which are currently being broadcast can be easily compared with those edited by the user, and a desired program can be prevented from being missed. When the two EPGs are displayed with a link between them, the concept of an original broadcast station can also be realized.

A case wherein the user sets the playback order, playback start time, and the like has been described above. However, the playback order, playback start time, and the like may be automatically formed. For example, the CPU 7 for controlling reserved recording and automatic playback collects various pieces of log information for recording by the user, playback order setting by the user, playback start time setting by the user, and actual playback. The pieces of collected log information are stored in the memory 4. The CPU 7 learns the taste and habit of the user from the log information and automatically re-forms the playback order, playback start time, and the like. For example, on the basis of log information, the number of times of watching recorder programs is represented as a score in units of program genres, it is determined which program genre of recorded programs has a high frequency of watching, and the playback order is formed such that a program genre with a high frequency of watching is preferentially played back.

Automatic re-formation will be described with reference to FIG. 8. As described above, when recording is reserved in the state wherein the pieces of log information are collected by the CPU 7 (ST41), the user is asked about an automatic re-formation request (ST42). If the user does not request automatic re-formation (NO in ST42), the flow advances to manual re-formation shown in ST13 to ST15 (ST47). If the user requests automatic re-formation (YES in ST42), the playback order of programs reserved for recording is determined on the basis of log information (ST43), and the playback start time is also determined on the basis of the log information (ST44). At this time, the program reserve window as shown in FIG. 3 or 4 is displayed. The contents of playback are confirmed on this window. If no change in setting is needed (YES in ST45), the reserve processing is ended in accordance with confirmation operation. To change the setting (NO in ST45), the flow advances to manual re-formation show in ST13 to ST15 (ST47).

By the above automatic re-formation, playback reserve in recording reserve can be partially omitted (when automatic re-formation setting is to be changed) or wholly omitted (when automatic re-formation setting is not to be changed). That is, an automatic playback environment with excellent operability for the user can be provided.

The present invention is not limited to the above embodiments, and various changes and modifications can be made without departing from the spirit and scope of the invention. The embodiments can be appropriately combined as much as possible. In this case, combined effects are obtained. The embodiments incorporate inventions of various phases, and various inventions can be extracted by appropriately combining a plurality of disclosed constituting elements. For example, even when some constituting elements are omitted from all the constituting elements disclosed in the embodiments, the problem described in the section “problem to be solved by the invention” can be solved. When the effect described in the section “effect of the invention” is obtained, the arrangement without these constituting elements can be extracted as an invention.

According to the present invention, a playback apparatus and method capable of timely playing back a recorded program can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A playback apparatus comprising:
reservation controller for recording a plurality of desired programs on a recording medium so as to reserve in advance a playback order of the plurality of recorded programs;
creator for creating a user original program guide on the basis of the playback order reserved by said reservation controller; and
reproducer for playing back the plurality of recorded programs in an order based on the program guide.

2. An apparatus according to claim 1, comprising playback order controller for automatically controlling the playback order of the plurality of recorded programs on the basis of at least one of the playback order reserved by said reservation controller and a log of executed playback.

3. An apparatus according to claim 1, comprising
playback mode selector for selecting a manual playback mode or automatic playback mode in correspondence with mode selection operation,
playback start instructor for instructing playback start in correspondence with playback start operation,
setter for setting a playback start time in correspondence with playback start time input operation, and
playback controller for starting playback of the plurality of recorded programs in the order based on the program guide when the manual playback mode is selected by said selector and the playback start is instructed by said playback start instructor, and starting playback of the plurality of recorded programs in the order based on the program guide when the automatic playback mode is selected by said selector and the playback start time set by said setter comes.

4. An apparatus according to claim 1, comprising display for displaying the program guide in correspondence with program guide display operation.

5. A playback apparatus comprising:
reservation controller for reserving recording of desired programs and a playback order of the recorded programs; and
reproducer for playing back the recorded programs in the playback order reserved by said reservation controller.

6. An apparatus according to claim 5, comprising playback order controller for automatically controlling the playback order of the recorded programs on the basis of at least one of the playback order reserved by said reservation controller and a log of executed playback.

7. An apparatus according to claim 5, comprising
playback mode selector for selecting a manual playback mode or automatic playback mode in correspondence with mode selection operation,
playback start instructor for instructing playback start in correspondence with playback start operation,
setter means for setting a playback start time in correspondence with playback start time input operation, and
playback controller for starting playback of the recorded programs in the playback order reserved by said reservation controller when the manual playback mode is selected by said selector and the playback start is instructed by said playback start instructor, and starting playback of the recorded programs in the playback order reserved by said reservation controller when the automatic playback mode is selected by said selector and the playback start time set by said setter comes.

8. An apparatus according to claim 5, comprising
playback order controller for automatically controlling the playback order of the plurality of recorded programs on the basis of at least one of the playback order reserved by said reservation controller and a log of executed playback,
playback mode selector for selecting a manual playback mode or automatic playback mode in correspondence with mode selection operation,
playback start instructor for instructing playback start in correspondence with playback start operation,
setter for setting a playback start time in correspondence with playback start time input operation, and
playback controller for starting playback of the plurality of recorded programs in the playback order reserved by said reservation controller when the manual playback mode is selected by said selector and the playback start is instructed by said playback start instructor, and starting playback of the plurality of recorded programs in the playback order reserved by said reservation controller when the automatic playback mode is selected by said selector and the playback start time set by said setter means comes.

9. A playback apparatus comprising:
reserve means for recording a plurality of desired programs on a recording medium and reserving in advance a playback order of the plurality of recorded programs;
creation means for creating a linked program guide which links a user original program guide based on the playback order reserved by said reserve means with a program guide corresponding to broadcast corresponding to current broadcast; and
playback means for playing back the plurality of recorded programs in an order based on the linked program guide.

10. An apparatus according to claim 9, comprising display means for displaying the linked program guide in correspondence with program guide display operation.

11. A playback method comprising:
the first step of reserving in advance a playback order of a plurality of recorded programs;
the second step of creating a user original program guide on the basis of the playback order reserved in the first step; and
the third step of playing back the plurality of recorded programs in an order based on the program guide created in the second step.

12. A method according to claim 11, comprising the step of controlling the playback order of the plurality of recorded programs on the basis of at least one of the playback order reserved in the first step and a log of executed playback.

13. A method according to claim 11, comprising the steps of
starting playback of the plurality of recorded programs in the order based on the program guide created in the second step when a manual playback mode is selected and playback start is instructed, and
starting playback of the plurality of recorded programs in the order based on the program guide created in the second step when an automatic playback mode is selected and a preset playback start time comes.

14. A method according to claim 11, comprising the step of displaying the program guide in correspondence with program guide display operation.

15. A playback method comprising:
the first step of reserving recording of desired programs and a playback order of the recorded programs; and
the second step of playing back the recorded programs in the playback order reserved in the first step.

16. A method according to claim 15, comprising the step of controlling the playback order of the recorded programs on the basis of at least one of the playback order reserved in the first step and a log of executed playback.

17. A method according to claim 15, comprising the steps of
starting playback of the recorded programs on the basis of the playback order reserved in the first step when a manual playback mode is selected and playback start is instructed, and
starting playback of the recorded programs on the basis of the playback order reserved in the first step when an automatic playback mode is selected and a preset playback start time comes.

18. A method according to claim 15, comprising the steps of
controlling the playback order of the recorded programs on the basis of at least one of the playback order reserved in the first step and a log of executed playback,
starting playback of the recorded programs on the basis of the playback order reserved in the first step when a manual playback mode is selected and playback start is instructed, and
starting playback of the recorded programs on the basis of the playback order reserved in the first step when an automatic playback mode is selected and a preset playback start time comes.

19. A playback method comprising:
the first step of reserving in advance a playback order of a plurality of recorded programs;
the second step of creating a linked program guide which links a user original program guide based on the playback order reserved in the first step with a program guide corresponding to broadcast corresponding to current broadcast; and
the third step of playing back the plurality of recorded programs in an order based on the linked program guide created in the second step.

20. A method according to claim 19, comprising the step of displaying the linked program guide in correspondence with program guide display operation.
